(19) United States
(12) Patent Application Publication
(10) Pub. No.: US 2018/0044006 A1
(43) Pub. Date: Feb. 15, 2018

(54) SPLICE CAP NICKEL ABRASION STRIP CAUL

(71) Applicant: Sikorsky Aircraft Corporation, Stratford, CT (US)

(72) Inventors: Ryan Lehto, Crowley, TX (US); Sven Roy Lofstrom, Irving, TX (US)

(21) Appl. No.: 15/232,287

(22) Filed: Aug. 9, 2016

(51) Int. Cl. B64C 27/46; B29C 65/48; B29C 65/02

(52) U.S. Cl. CPC B64C 27/46; B29C 65/02; B29C 65/48; B29L 2031/3076

(57) ABSTRACT

A caul assembly includes a semi-rigid caul plate formed in a shape complementary to a portion of a component receivable therein and a heater located at an exterior surface of the semi-rigid caul plate. The heater is adapted to apply heat to a localized portion of the component.

### BACKGROUND OF THE INVENTION

Exemplary embodiments of the invention relate to a rotary-wing aircraft and, more particularly, to a main rotor blade of a rotary-wing aircraft.

Rotary wing aircraft include a plurality of main rotor blades coupled to a central hub. The rotor blades include aerodynamic surfaces that, when rotated, create lift. The configuration of the main rotor blades, particularly the tip section thereof, is selected to enhance rotor blade performance, for example to increase the hover and lift capabilities of the rotary-wing aircraft. Rotor blades are subjected to high stresses and strains resulting from aerodynamic forces developed during operation.

The leading edges of helicopter rotor blades are subject to wear, such as fatigue wear for example, due to vibratory loads. In particular there is a recurring problem of erosion of the metal leading edge abrasion strips of the main rotor blades. When such erosion occurs, the affected rotor blades must be removed from the helicopter and sent for repair, resulting in several weeks of downtime for the aircraft.

### BRIEF DESCRIPTION OF THE INVENTION

According to one embodiment of the invention, a caul assembly includes a semi-rigid caul plate formed in a shape complementary to a portion of a component receivable therein and a heater located at an exterior surface of the semi-rigid caul plate. The heater being adapted to apply heat to a localized portion of the component.

In addition to one or more of the features described above, or as an alternative, in further embodiments the heater includes a plurality of regions and a temperature of each of the plurality of regions is generally identical.

In addition to one or more of the features described above, or as an alternative, in further embodiments the heater includes a plurality of regions and a temperature of at least one of the plurality of regions is different.

In addition to one or more of the features described above, or as an alternative, in further embodiments a plurality of wires associated with the heater is consolidated at a leader tab extending from an edge of the caul assembly.

In addition to one or more of the features described above, or as an alternative, in further embodiments comprising a control cabinet configured to control a supply of power to the heater.

In addition to one or more of the features described above, or as an alternative, in further embodiments a shape of the caul assembly is complementary to a portion of a rotor blade.

In addition to one or more of the features described above, or as an alternative, in further embodiments the shape of the caul assembly is complementary to a portion of the rotor blade including an outboard splice cap abrasion strip.

According to another embodiment, a method of bonding a splice cap abrasion strip to a rotor blade includes installing the splice cap abrasion strip to a leading edge of the rotor blade and applying localized heat and pressure to the splice cap abrasion strip to bond the splice cap abrasion strip to the rotor blade.

In addition to one or more of the features described above, or as an alternative, in further embodiments applying localized heat includes installing a caul assembly including a heater in overlapping arrangement with the splice cap abrasion strip.

In addition to one or more of the features described above, or as an alternative, in further embodiments a power supply is operably coupled to the caul assembly.

In addition to one or more of the features described above, or as an alternative, in further embodiments the localized heat applied by the heater is non-uniform across the caul assembly.

In addition to one or more of the features described above, or as an alternative, in further embodiments applying localized pressure includes installing a vacuum bag over a tip section of the rotor blade and the splice cap abrasion strip.

In addition to one or more of the features described above, or as an alternative, in further embodiments a vacuum is operably coupled to a port of the vacuum bag.

In addition to one or more of the features described above, or as an alternative, in further embodiments the splice cap abrasion strip is formed from a nickel material.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a perspective view of an example of a rotary wing aircraft;

FIG. 2 is a perspective view of an example of a rotor blade of a rotary wing aircraft;

FIG. 3 is an exploded perspective view of the component of a portion of the rotor blade of FIG. 2;

FIG. 4 is an exploded perspective view of the tip end assembly of a rotor blade according to an embodiment;

FIG. 5 is a perspective view of a caul for bonding a portion of the tip end assembly according to an embodiment;

FIG. 6 is a perspective view of a rotor blade as the splice cap nickel abrasion strip is mounted to the rotor blade according to an embodiment; and

FIG. 7 is a block diagram illustrating a method of using the bonding fixture to bond the outboard splice cap to a rotor blade according to an embodiment.

The detailed description explains embodiments of the invention, together with advantages and features, by way of example with reference to the drawings.

### DETAILED DESCRIPTION OF THE INVENTION

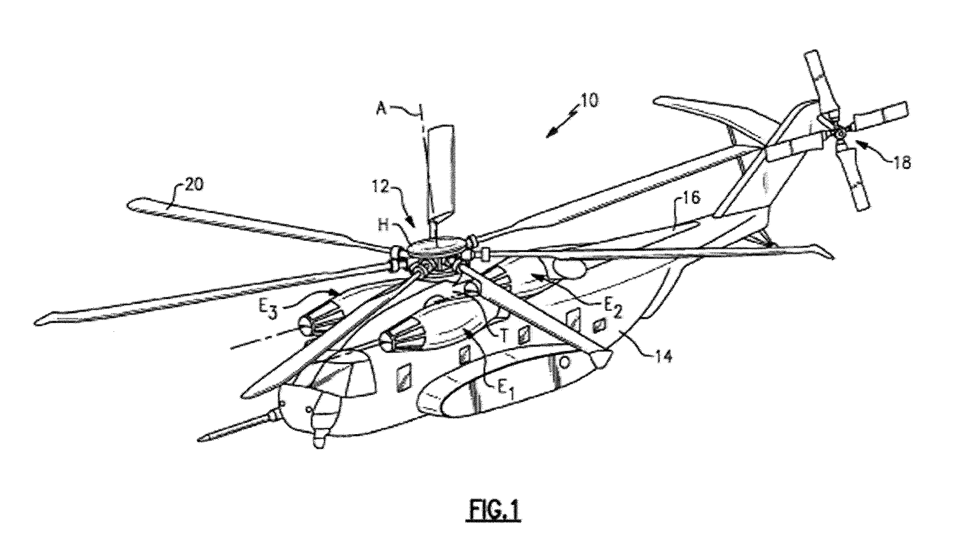

FIG. 1 schematically illustrates a rotary-wing aircraft 10 having a main rotor system 12. The aircraft 10 includes an airframe 14 having an extending tail 16 which mounts a tail rotor system 18, such as an anti-torque system for example. The main rotor assembly 12 is driven about an axis of rotation A through a main gearbox (illustrated schematically at T) by one or more engines E. The main rotor system 12 includes a plurality of rotor blade assemblies 20 mounted to a rotor hub assembly H. Although a particular helicopter configuration is illustrated and described in the disclosed non-limiting embodiment, other configurations and/or machines, such as high speed compound rotary-wing aircraft with supplemental translational thrust systems, dual contra-rotating, coaxial rotor system aircraft, turbo-props, tilt-rotors, and tilt-wing aircraft are also within the scope of the invention.

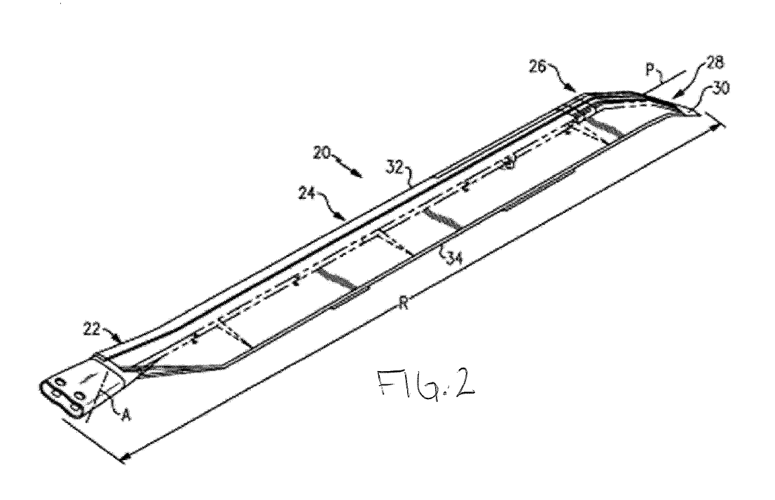

Referring to FIG. 2, each rotor blade assembly 20 of the rotor assembly 12 generally includes a root section 22, an intermediate section 24, a tip section 26, and a tip cap 28. Each rotor blade section 22, 24, 26, 28 may define particular airfoil geometries to tailor the rotor blade aerodynamics to the velocity increase along the rotor blade span. As, illustrated, the rotor blade tip section 26 may include an anhedral form (not shown); however, any angled or non-angled forms such as cathedral, gull, bent, and other non-straight forms are within the scope of the present invention. The anhedral form as defined herein may include a rotor blade tip section 26 which extends at least partially out of a plane defined by the intermediate section 24.

The rotor blade sections 22-28 define a span R of the main rotor blade assembly 20 between the axis of rotation A and a distal end 30 of the tip cap 28 such that any radial station may be expressed as a percentage in terms of a blade radius x/R. The rotor blade assembly 20 defines a longitudinal feathering axis P between a leading edge 32 and a trailing edge 34.

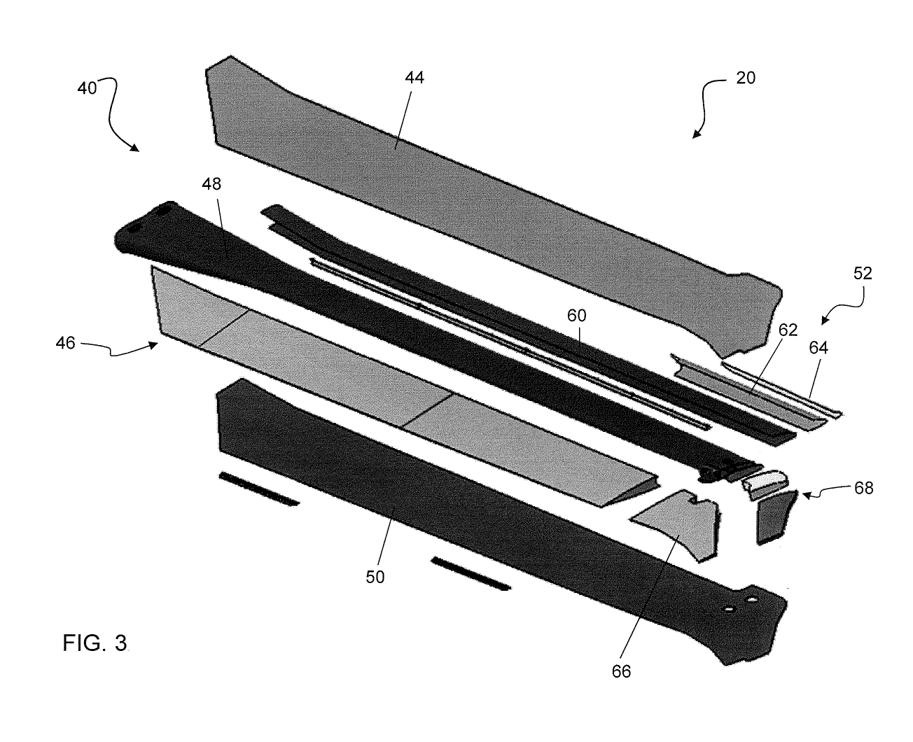

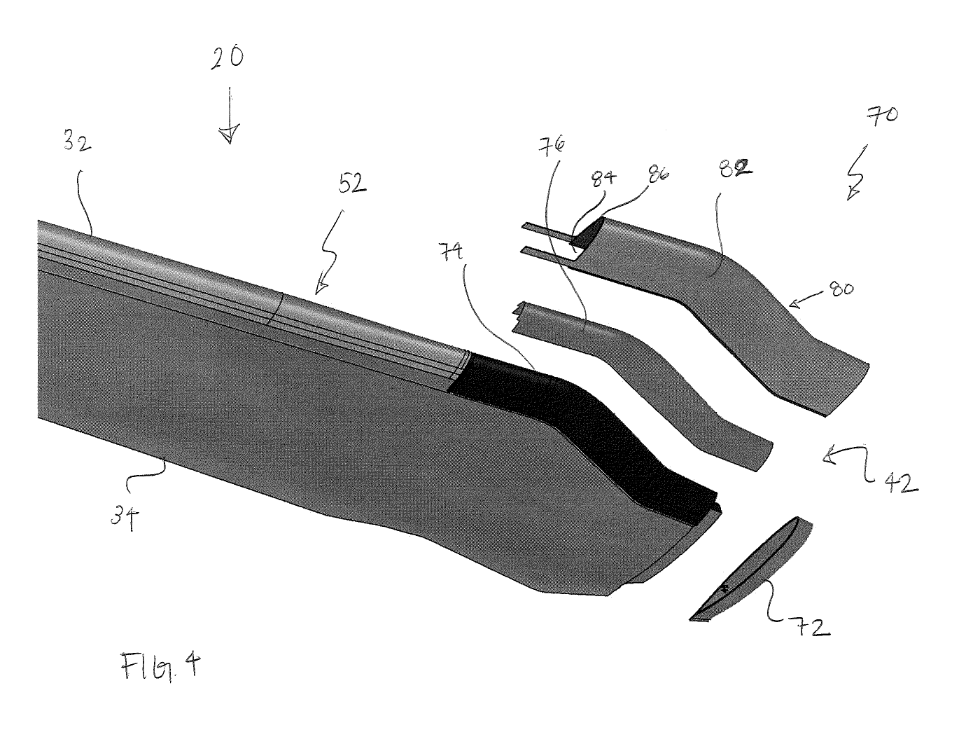

Referring now to FIGS. 3 and 4, the rotor blade assembly 20 generally includes a main blade assembly 40 and a tip assembly 42. The main blade assembly 40 includes an upper skin 44, a main core 46, a spar 48, a lower skin 50, and a leading edge assembly 52. The main spar 48, main core 46, and skins 44, 50 are generally referred to as a pocket assembly, the forward portion of which is closed out by the leading edge assembly 52. The main core 46 may be formed from a single core piece or a plurality of separate core pieces, each of which may be fabricated from a distinct core material to provide particular lift and strength properties. The spar 48 has a generally constant thickness over most of its length.

The leading edge assembly 52 generally includes a main sheath laminate 60 upon which is mounted a wear-resistant material, such as an abrasion resistant system for example. In the non-limiting embodiment illustrated, the abrasion resistant system can be multiple strips, such as a first erosion strip 62 and a second erosion strip 64 to provide abrasion protection. Additional structures, such as weight cups, leading edge counter weights, and trim tab systems for example, may also be provided, in a manner known to a person having ordinary skill in the art. Although not shown, it should be understood that in some embodiments a heater mat may be positioned around a portion of the rotor blade 20, such as about the leading edge between the spar 48 and the main sheath laminate 60 or between the main sheath 60 and an adjacent erosion strip for example.

The tip assembly 42 generally includes a main tip core 66, a tip end core 68, a tip leading edge assembly 70, and a tip cap 72. The main tip core 66 is substantially aligned with a longitudinal axis of the main core 46 and is positioned directly adjacent the end of the main core 46. The tip cap 72 is configured to removably couple to the tip end core 68 at the distal end of the rotor blade 20.

With reference now to FIG. 4, the tip leading edge assembly 70 is illustrated in more detail. The tip leading edge assembly 70 includes an intermediate splice cap 74 and an outboard splice cap 76 configured to provide abrasion protection. The intermediate splice cap 74 and the outboard splice cap 76 are formed from any suitable material, including but not limited to, titanium, nickel, or a variety of other wear-resistant materials or combinations thereof. The intermediate splice cap 74 and the outboard splice cap 76 are both positioned to overlap the first erosion strip 62 and abut the second erosion strip 64 at a tip interface. As a result of this configuration, it is possible to replace the second erosion strip 64 without affecting or having to remove or replace any portion of the tip assembly 42.

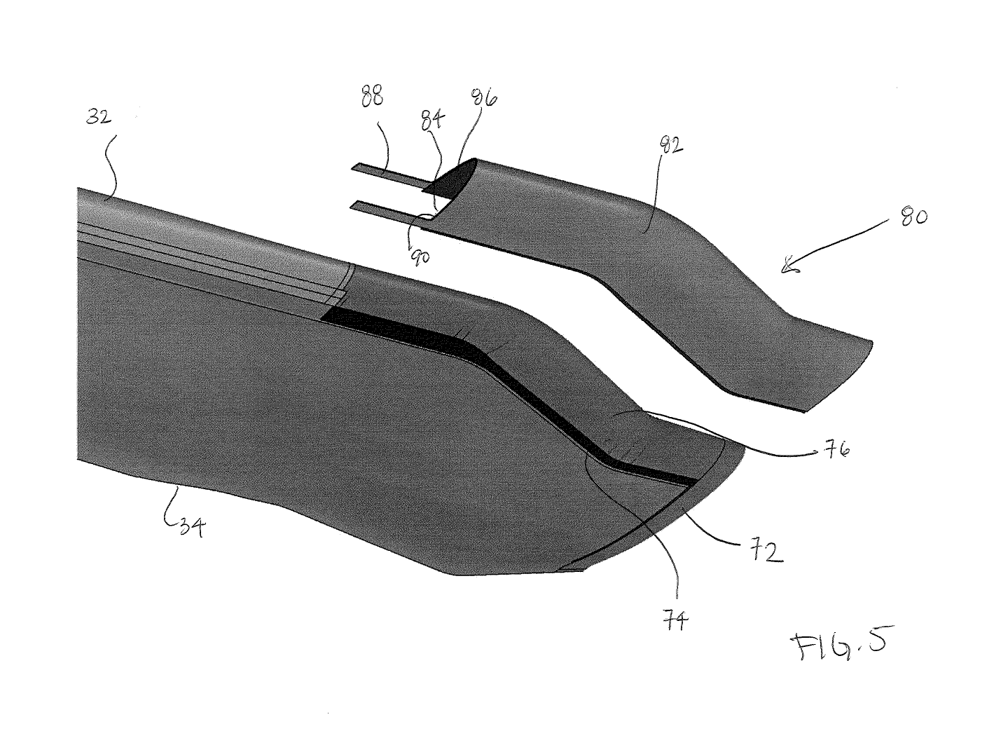

A caul assembly 80, best shown in FIG. 5, is used to bond the outboard splice cap abrasion strip 76 to the leading edge 32 of the rotor blade 20. The caul assembly 80 includes a semi-rigid caul plate 82, such as formed from a carbon fiber material for example. As shown, the caul plate 82 is formed in a specific shape generally complementary to the leading edge 32 of the rotor blade 20 at the tip assembly 42, or at the interface between the leading edge assembly 52 and the tip leading edge assembly 70. The caul plate 82 is configured to conform the material of the outboard splice cap abrasion strip 76 into a desired structure. The caul plate 82 defines a cavity 84 within which the leading edge 32 of the rotor blade 20 is received such that the caul plate 82 substantially covers the entire surface of the outboard splice cap abrasion strip 76.

A heater blanket 86 is mounted to or integrally formed with an exterior surface of the caul plate 82 such that heat from the heater blanket 86 is transmitted through the caul plate 82 to the splice cap abrasion strip 76 when the caul assembly 80 is installed about the rotor blade 20. The heater blanket 86 includes one or more heating elements (not shown) configured to generate the heat necessary for the bonding process. In an embodiment, the wiring of the at least one heating element is consolidated and exposed via a leader tab 88 extending outwardly from an end 90 of the caul assembly 80. A control cabinet controls power output to a single heater or multi-zoned heater. A power supply is configured to couple to the leader tab 88 to control power output to the heater blanket 86.

Depending on the construction of the heating element, the heat output from the heater blanket 86 may be constant, or may vary across at least one of the span and the chord of the rotor blade 20. The heater blanket 86 may include one or more regions or zones to accommodate variations in thermal cycling and ensure even heating across the outboard splice cap abrasion strip 76 during the adhesive cure. In such embodiments, the temperature across the various regions of the heater blanket 86 may be the same, or may vary. In an embodiment, the thermal cycling of the zones adjacent the ends of the outboard splice cap abrasion strip 76, such as adjacent the interface with the leading edge assembly 52 and adjacent the tip cap 72 for example, is greater than at a central portion of the heater blanket 86.

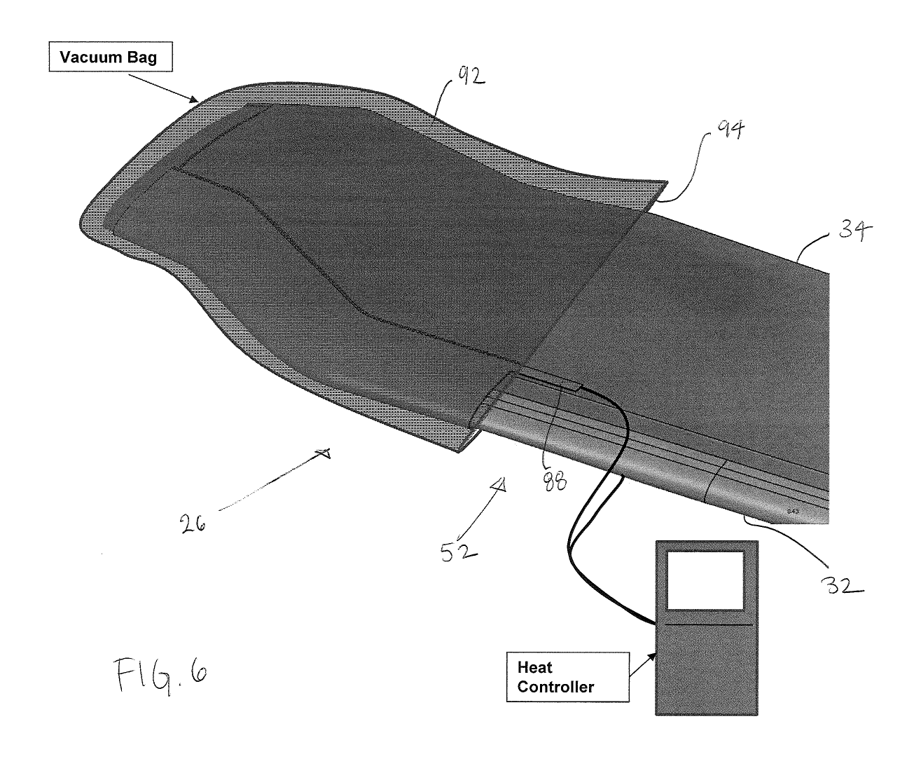

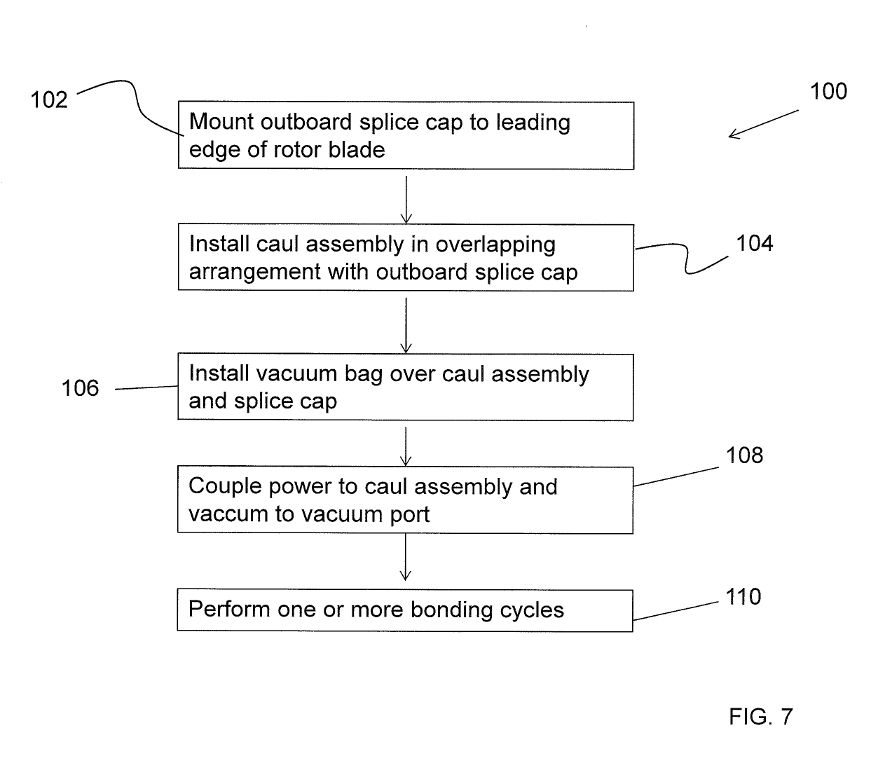

A method 100 of bonding the outboard splice cap abrasion strip 76 to the leading edge 32 of a rotor blade 20 is illustrated in more detail in FIG. 7. In block 102, the outboard splice cap abrasion strip 76 is prepped for bonding by applying an adhesive to the surface of the outboard splice cap abrasion strip 76 configured to contact the rotor blade 20 and then locating the outboard splice cap abrasion strip 76 onto the leading edge 32. In block 104, the caul assembly 80 is then mounted to the leading edge 32 of the rotor blade 20 in an overlapping relationship with the outboard splice cap abrasion strip 76. A vacuum bag 92 (see FIG. 6) or another component configured to apply positive pressure to the exterior of the rotor blade 20 is mounted about the tip section 26 of the rotor blade 20 in block 106. The open end 94 of the vacuum bag 92 is taped to a surface of the rotor blade 20 such that the caul assembly 80 and the outboard splice cap abrasion strip 76 are substantially enclosed within the vacuum bag 92. In an embodiment, the connections, such as the leader tabs 88 for example, for supplying power to the caul assembly 80 is disposed outside the vacuum bag 92. Inclusion of the leader tab 88 simplifies the vacuum bagging process and eliminates a leak path generated when not using a consolidated tab. In block 108, a power supply, for example operated by a controller 96, is coupled to the heater blanket 86 to energize the one or more heating elements of the heater blanket 86, and a vacuum is operably coupled to a vacuum port of the vacuum bag 92. In block 110, heat and positive pressure are simultaneously applied to the exterior of the rotor blade 20 to bond the outboard splice cap abrasion strip 76 to the rotor blade 20.

The caul assembly illustrated and described herein allows a component, such as an outboard splice cap abrasion strip for example, to be bonded to a rotor blade at room temperature or at an elevated temperature without the need for positioning the rotor blade in a large walk-in oven. As a result, manufacturing and maintenance of the rotor blade may be performed more easily and with an improved process time.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions or equivalent arrangements not heretofore described, but which are commensurate with the spirit and scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. A caul assembly, comprising:
a semi-rigid caul plate having a shape complementary to a portion of a component receivable therein; and
a heater located at an exterior surface of the semi-rigid caul plate, the heating being adapted to apply heat to a localized portion of the component.

2. The caul assembly according to claim 1, wherein the heater includes a plurality of regions and a temperature of each of the plurality of regions is generally identical.

3. The caul assembly according to claim 1, wherein the heater includes a plurality of regions and a temperature of at least one of the plurality of regions is different from that of at least one of the other regions.

4. The caul assembly according to claim 1, wherein a plurality of wires associated with the heater is consolidated at a leader tab extending from an edge of the caul assembly.

5. The caul assembly according to claim 1, further comprising a control cabinet configured to control a supply of power to the heater.

6. The caul assembly according to claim 1, wherein a shape of the caul assembly is complementary to a portion of a rotor blade.

7. The caul assembly according to claim 6, wherein the shape of the caul assembly is complementary to a portion of the rotor blade including an outboard splice cap abrasion strip.

8. A method of bonding a splice cap abrasion strip to a rotor blade comprising:
installing the splice cap abrasion strip to a leading edge of the rotor blade; and
applying localized heat and pressure to the splice cap abrasion strip to bond the splice cap abrasion strip to the rotor blade.

9. The method according to claim 8, wherein applying localized heat includes installing a caul assembly including a heater in overlapping arrangement with the splice cap abrasion strip.

10. The method according to claim 9, wherein a power supply is operably coupled to the caul assembly.

11. The method according to claim 9, wherein the localized heat applied by the heater is non-uniform across the caul assembly.

12. The method according to claim 8, wherein applying localized pressure includes installing a vacuum bag over a tip section of the rotor blade and the splice cap abrasion strip.

13. The method according to claim 12, wherein a vacuum is operably coupled to a port of the vacuum bag.

14. The method according to claim 8, wherein the splice cap abrasion strip is formed from a nickel material.
